(19) United States
(12) Patent Application Publication
(10) Pub. No.: US 2012/0279206 A1
(43) Pub. Date: Nov. 8, 2012

(54) DEVICE, METHOD, AND SYSTEM FOR EMISSIONS CONTROL

(76) Inventors: STEPHEN MARK GEYER, Lawrence Park, PA (US); Shashi Kiran, Lawrence Park, PA (US); Paul Llovd Flynn, Lawrence Park, PA (US)

(21) Appl. No.: 13/217,313

(22) Filed: Aug. 25, 2011

Related U.S. Application Data
(63) Continuation-in-part of application No. 13/098,509, filed on May 2, 2011.

(51) Int. Cl. F01N 9/00; B01D 53/34; B01D 53/94

(52) U.S. Cl. 60/287; 423/212; 422/171; 423/213.5

(57) ABSTRACT

An exhaust gas treatment device includes a first substrate coated with a low temperature catalyst configured to facilitate formation of an oxidizer when an exhaust gas temperature is below a threshold temperature. The device further includes a second substrate coated with a high temperature catalyst and positioned coaxially with the first substrate, the high temperature catalyst configured to facilitate formation of the oxidizer when the exhaust gas temperature is above the threshold temperature.

### CROSS REFERENCE TO RELATED APPLICATIONS

This application is a continuation-in-part of U.S. patent application Ser. No. 13/098,509 filed May 2, 2011, the disclosure of which is incorporated by reference in its entirety for all purposes.

### FIELD

Embodiments of the subject matter disclosed herein relate to exhaust gas treatment devices and systems for an engine.

### BACKGROUND

An exhaust gas treatment device may be included in an exhaust system of an engine in order to reduce regulated emissions. In one example, the exhaust gas treatment device may include an oxidation catalyst disposed upstream of a particulate filter. The oxidation catalyst typically includes a catalyst which oxidizes carbon monoxide and hydrocarbons, as well as converts nitric oxide to nitrogen dioxide. In such an example, nitrogen dioxide generated by the catalyst flows downstream to the diesel particulate filter where it oxidizes particulate matter trapped in the particulate filter, thereby passively regenerating the particulate filter.

During operation at elevated exhaust temperatures (e.g., greater than 500° C.), such as during tunneling operation (where a vehicle in which the engine is positioned is travelling through a tunnel or other enclosed area), the catalyst may degrade. As a result, when the temperature of the exhaust gas decreases, conversion activity of the oxidation catalyst may be reduced such that less nitrogen dioxide is generated by the oxidation catalyst resulting in a reduced passive regeneration rate of the particulate filter and an increased active regeneration rate. During active regeneration, the exhaust temperature may be driven up to a temperature at which the particulate matter trapped in the particulate filter will burn; however, such temperatures may result in further degradation of a catalyst that is active in a lower temperature range (e.g., less than 500° C.).

### BRIEF DESCRIPTION

In one embodiment, an exhaust gas treatment device includes a first substrate coated with a first, low temperature catalyst configured to facilitate formation of an oxidizer when an exhaust gas temperature is below a threshold temperature. The exhaust gas treatment device further includes a second substrate coated with a second, high temperature catalyst and positioned coaxially with the first substrate, the high temperature catalyst configured to facilitate formation of the oxidizer when the exhaust gas temperature is above the threshold temperature.

In such a configuration, high temperature exhaust gas (e.g., exhaust gas with a temperature greater than the threshold temperature) may selectively flow through the second substrate coated with the second, high temperature catalyst. For example, the second substrate may have a lower cell density than the first substrate, which is preferred by the high temperature exhaust gas flow. As such, a reduced amount of high temperature exhaust gas may flow through the first substrate coated with the first, low temperature catalyst. Further, by positioning the substrates coaxially, each substrate is in proximity to the heat source (e.g., the exhaust gas). In this manner, a temperature of the substrate may or will not fall below an activation temperature of the catalyst during periods of reduced exhaust flow, and oxidizer formation may be resumed quickly when exhaust gas flow through the substrate is resumed. Thus, oxidizer formation may occur over a wide range of temperatures (e.g., above and below the threshold temperature), while degradation of the catalysts is reduced.

It should be understood that the brief description above is provided to introduce, in simplified form, a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a schematic diagram of an exemplary embodiment of a rail vehicle with an exhaust gas treatment device according to an embodiment of the invention.

FIG. 2 shows a perspective view, approximately to scale, of an engine with a turbocharger and an exhaust gas treatment device.

FIG. 3 shows a perspective view, approximately to scale, of an exemplary embodiment of an engine cab.

FIG. 4 shows a schematic diagram of an exemplary embodiment of an exhaust gas treatment device according to an embodiment of the invention.

FIG. 5 shows a graph illustrating particulate matter reduction in an exhaust gas treatment device as a function of temperature.

FIG. 6 shows a schematic diagram of an exemplary embodiment of an exhaust gas treatment device according to an embodiment of the invention.

FIG. 7 shows a flow chart illustrating a method for the use of an exhaust gas treatment device according to an embodiment of the invention.

FIG. 8 shows a perspective view of an oxidation catalyst device according to an embodiment of the invention.

FIG. 9 shows a schematic diagram of an exemplary embodiment of an exhaust gas treatment device which includes the oxidation catalyst device depicted in FIG. 8.

FIG. 10 shows a graph illustrating flow through a substrate based on exhaust gas temperature and substrate cell density.

FIG. 11 shows a perspective view of an oxidation catalyst device according to an embodiment of the invention.

FIG. 12 shows a schematic diagram of an exemplary embodiment of an exhaust gas treatment device which includes the oxidation catalyst device depicted in FIG. 11.

FIG. 13 shows a flow chart illustrating a method for use of an exhaust treatment device according to an embodiment of the invention.

### DETAILED DESCRIPTION

The following description relates to various embodiments of an exhaust gas treatment device which includes a first substrate coated with a first (low temperature) catalyst configured to facilitate formation of an oxidizer when an exhaust gas temperature is below a threshold temperature. As used herein, “low temperature catalyst” implies a catalyst that is active in a relatively low temperature range (e.g., between 300° C. and 500° C.). The exhaust gas treatment device further includes a second substrate coated with a second (high temperature) catalyst and positioned coaxially with the first substrate, the high temperature catalyst configured to facilitate formation of the oxidizer when the exhaust gas temperature is above the threshold temperature. As used herein, “high temperature catalyst” implies a catalyst that is active at relatively high temperatures (e.g., between 500° C. and 600° C.). It should be understood the temperature ranges “between 300° C. and 500° C.” and “between 500° C. and 600° C.” are provided as examples and are not meant to be limiting. As such, temperatures outside these ranges may also be used.

In some embodiments, the first substrate coated with the low temperature catalyst may have a higher cell density than the second substrate coated with the high temperature catalyst. As such, higher temperature exhaust gas may favor flow through the second substrate coated with the high temperature catalyst, and high temperature exhaust gas flow through the first substrate coated with the low temperature catalyst may be reduced. In other embodiments, a flow control element may be operably coupled to the first substrate such that a position of the flow control element governs an extent to which exhaust gas flows through the first substrate. In such an embodiment, the flow control element may be controlled to substantially reduce or block flow to the first substrate coated with the low temperature catalyst. In this manner, high temperature exhaust gas flow to the first substrate coated with the low temperature catalyst may be reduced such that degradation of the low temperature catalyst is reduced. Further, because the high temperature exhaust gas flows through the second substrate coated with the high temperature catalyst when the exhaust gas temperature is high, generation of the oxidizer may be maintained.

The approach described herein may be employed in a variety of engine types, and a variety of engine-driven systems. Some of these systems may be stationary, while others may be on semi-mobile or mobile platforms. Semi-mobile platforms may be relocated between operational periods, such as mounted on flatbed trailers. Mobile platforms include self-propelled vehicles. Such vehicles can include mining equipment, marine vessels, on-road transportation vehicles, off-highway vehicles (OHV), and rail vehicles. For clarity of illustration, a locomotive is provided as an example mobile platform supporting a system incorporating an embodiment of the invention.

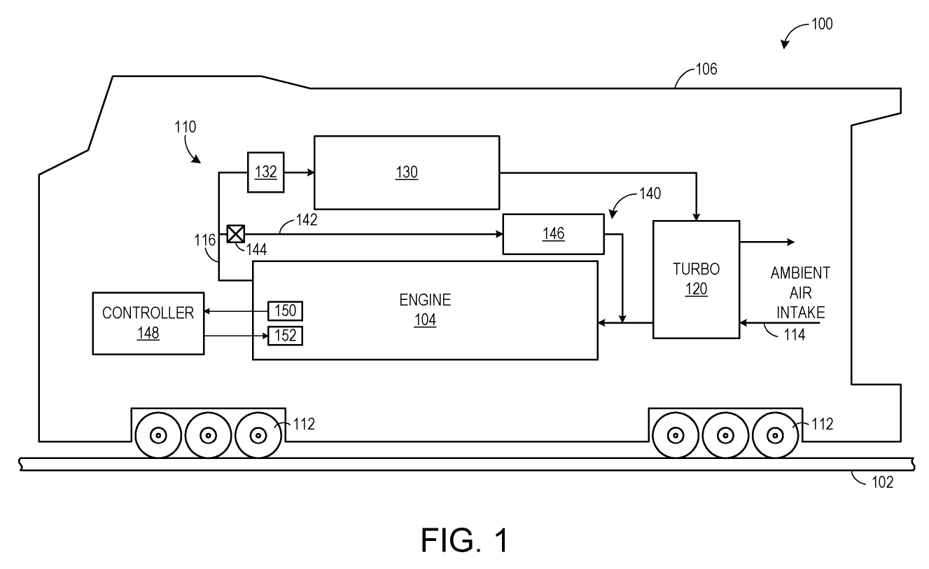

Before further discussion of the emissions control approach, an example of a platform is disclosed in which the exhaust gas treatment device may be configured for an engine in a vehicle, such as a rail vehicle. For example, FIG. 1 shows a block diagram of an exemplary embodiment of a vehicle system 100 (e.g., a locomotive system), herein depicted as a rail vehicle 106, configured to run on a rail 102 via a plurality of wheels 112. As depicted, the rail vehicle 106 includes an engine system 110 with an engine 104. In other non-limiting embodiments, the engine 104 may be a stationary engine, such as in a power-plant application, or an engine in a marine vessel or off-highway vehicle propulsion system as noted above.

The engine 104 receives intake air for combustion from an intake passage 114. The intake passage 114 receives ambient air from an air filter (not shown) that filters air from outside of the rail vehicle 106. Exhaust gas resulting from combustion in the engine 104 is supplied to an exhaust passage 116. Exhaust gas flows through the exhaust passage 116, and out of an exhaust stack (not shown) of the rail vehicle 106. In one example, the engine 104 is a diesel engine that combusts air and diesel fuel through compression ignition. In other non-limiting embodiments, the engine 104 may combust fuel including gasoline, kerosene, biodiesel, or other petroleum distillates of similar density through compression ignition (and/or spark ignition).

The engine system 110 includes a turbocharger 120 that is arranged between the intake passage 114 and the exhaust passage 116. The turbocharger 120 increases air charge of ambient air drawn into the intake passage 114 in order to provide greater charge density during combustion to increase power output and/or engine-operating efficiency. The turbocharger 120 may include a compressor (not shown) which is at least partially driven by a turbine (not shown). While in this case a single turbocharger is included, the system may include multiple turbine and/or compressor stages.

The engine system 110 further includes an exhaust gas treatment device 130 coupled in the exhaust passage upstream of the turbocharger 120. As will be described in greater detail below, the exhaust gas treatment device 130 may include one or more components. In one example embodiment, the exhaust gas treatment device 130 may include a diesel oxidation catalyst (DOC) and a diesel particulate filter (DPF), where the DOC is positioned upstream of the DPF in the exhaust gas treatment device. In other embodiments, the exhaust gas treatment device 130 may additionally or alternatively include a selective catalytic reduction (SCR) catalyst, three-way catalyst, NOₓ trap, various other emission control devices or combinations thereof.

Further, in some embodiments, a burner 132 may be included in the exhaust passage such that the exhaust stream flowing through the exhaust passage upstream of the exhaust gas treatment device may be heated. In this manner, a temperature of the exhaust stream may be increased to facilitate active regeneration of the exhaust gas treatment device. In other embodiments, a burner may not be included in the exhaust gas stream.

The engine system 110 further includes an exhaust gas recirculation (EGR) system 140, which routes exhaust gas from the exhaust passage 116 upstream of the exhaust gas treatment device 130 to the intake passage downstream of the turbocharger 120. The EGR system 140 includes an EGR passage 142 and an EGR valve 144 for controlling an amount of exhaust gas that is recirculated from the exhaust passage 116 of engine 104 to the intake passage 114 of engine 104. By introducing exhaust gas to the engine 104, the amount of available oxygen for combustion is decreased, thereby reducing the combustion flame temperatures and reducing the formation of nitrogen oxides (e.g., NOₓ). The EGR valve 144 may be an on/off valve controlled by the controller 148, or it may control a variable amount of EGR, for example. In some embodiments, as shown in FIG. 1, the EGR system 140 further includes an EGR cooler 146 to reduce the temperature of the exhaust gas before it enters the intake passage 114. As shown in the non-limiting example embodiment of FIG. 1, the EGR system 140 is a high-pressure EGR system. In other embodiments, the engine system 110 may additionally, or alternatively, include a low-pressure EGR system, routing EGR from downstream of the turbine to upstream of the compressor.

The rail vehicle 106 further includes a controller 148 to control various components related to the vehicle system 100. In one example, the controller 148 includes a computer control system. The controller 148 further includes computer readable storage media (not shown) including code for enabling on-board monitoring and control of rail vehicle operation. The controller 148, while overseeing control and management of the vehicle system 100, may be configured to receive signals from a variety of engine sensors 150, as further elaborated upon herein, in order to determine operating parameters and operating conditions, and correspondingly adjust various engine actuators 152 to control operation of the rail vehicle 106. For example, the controller 148 may receive signals from various engine sensors 150 including, but not limited to: engine speed; engine load; boost pressure; exhaust pressure; ambient pressure; exhaust temperature; etc. Correspondingly, the controller 148 may control the vehicle system 100 by sending commands to various components such as traction motors, alternator, cylinder valves, throttle, etc. In one example, the controller 148 may adjust the position of the EGR valve 144 in order to adjust an air-fuel ratio of the exhaust gas or to modulate a temperature of the exhaust gas.

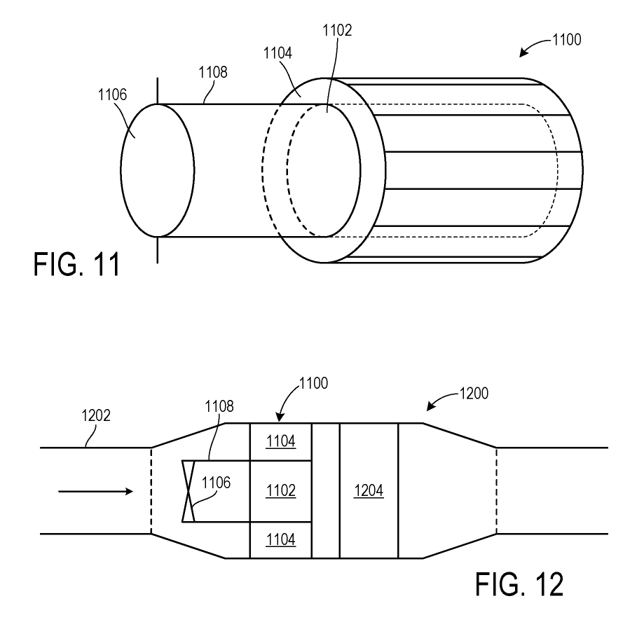

In another example, the controller 148 may be configured to identify a temperature of exhaust gas, and when the temperature of the exhaust gas is less than a threshold temperature, opening a flow control element to direct the exhaust gas through a first substrate, and when the temperature of the exhaust gas is greater than the threshold temperature, closing the flow control element to direct the exhaust gas through a second substrate. Such an example will be described in greater detail below with reference to FIGS. 11-13.

In one example embodiment, the vehicle system is a locomotive system which includes an engine cab defined by a roof assembly and side walls. The locomotive system further comprises an engine positioned in the engine cab such that a longitudinal axis of the engine is aligned in parallel with a length of the cab. Further, an exhaust gas treatment device is included, and is mounted on the engine within a space defined by a top surface of an exhaust manifold of the engine, the roof assembly, and the side walls of the engine cab such that a longitudinal axis of the exhaust gas treatment device is aligned in parallel with the longitudinal axis of the engine. The exhaust gas treatment device includes a first substrate coated with a low temperature catalyst positioned upstream of a second substrate coated with a high temperature catalyst. The exhaust gas treatment device is disposed upstream of a turbine of the turbocharger and configured to receive exhaust gas from the exhaust manifold of the engine.

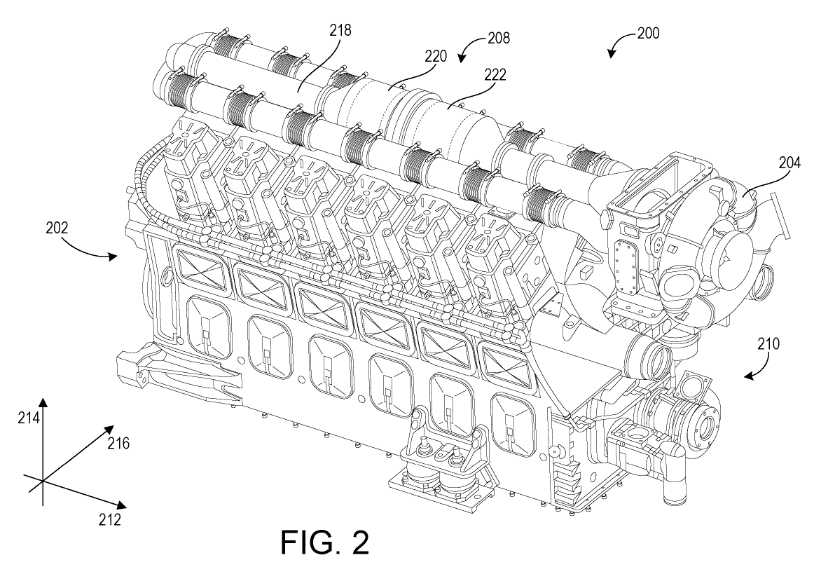

Turning to FIG. 2, an exemplary engine system 200 is illustrated, the engine system 200 including an engine 202, such as the engine 104 described above with reference to FIG. 1. FIG. 2 is approximately to-scale. The engine system 200 further includes a turbocharger 204 mounted on a front side of the engine and an exhaust gas treatment device 208 positioned on a top portion of the engine.

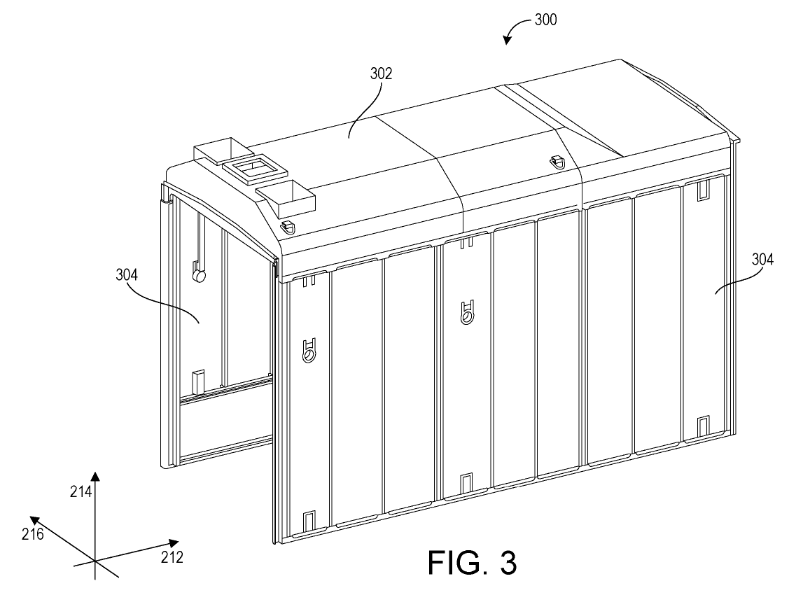

In the example of FIG. 2, engine 202 is a V-engine which includes two banks of six cylinders that are positioned at an angle of less than 180 degrees with respect to one another such that they have a V-shaped inboard region and appear as a V when viewed along a longitudinal axis of the engine. The longitudinal axis of the engine is defined by its longest dimension in this example. In the example of FIG. 2, and in FIG. 3, the longitudinal direction is indicated by 212, the vertical direction is indicated by 214, and the lateral direction is indicated by 216. Each bank of cylinders includes a plurality of cylinders. Each of the plurality of cylinders includes an intake valve which is controlled by a camshaft to allow a flow of compressed intake air to enter the cylinder for combustion. Each of the cylinders further includes an exhaust valve which is controlled by the camshaft to allow a flow of combusted gases (e.g., exhaust gas) to exit the cylinder.

In the example embodiment of FIG. 2, the exhaust gas exits the cylinder and enters an exhaust manifold positioned within the V (e.g., in an inboard orientation). In other embodiments, the exhaust manifold may be in an outboard orientation, for example, in which the exhaust manifold is positioned outside of the V. In the example of FIG. 2, the engine 202 is a V-12 engine. In other examples, the engine may be a V-6, V-16, I-4, I-6, I-8, opposed 4, or another engine type.

As mentioned above, the engine system 200 includes a turbocharger 204 positioned at a front end 210 of the engine 202. In the example of FIG. 2, the front end 210 of the engine 202 is facing toward a right side as shown. Intake air flows through the turbocharger 204 where it is compressed by a compressor of the turbocharger before entering the cylinders of the engine 202. In some examples, the engine 202 further includes a charge air cooler which cools the compressed intake air before it enters the cylinder of the engine 202. The turbocharger 204 is coupled to the exhaust manifold of the engine 202 such that exhaust gas exits the cylinders of the engine 202 and then flows through an exhaust passage 218 and enters an exhaust gas treatment device 208 before entering a turbine of the turbocharger 204. At locations upstream of the turbocharger, exhaust gas may have a higher temperature and a higher volume flow rate than at locations downstream of the turbocharger due to decompression of the exhaust gas upon passage through the turbocharger.

In other embodiments, the exhaust gas treatment device 208 may be positioned downstream of the turbocharger 204. As an example, if the exhaust gas treatment device is positioned in a rail vehicle that passes through tunnels (e.g., tunneling operation), a temperature of the exhaust gas may increase upon passage through a tunnel. In such an example, exhaust gas may have a higher temperature after passing through the turbocharger and passive regeneration of the exhaust gas treatment may occur, as will be described in greater detail below.

In the exemplary embodiment shown in FIG. 2, the exhaust gas treatment device 208 is positioned vertically above the engine 202. The exhaust gas treatment device 208 is positioned on top of the engine 202 such that it fits within a space defined by a top surface of an exhaust manifold of the engine 202, a roof assembly 302 of an engine cab 300, and the side walls 304 of the engine cab. The engine cab 300 is illustrated in FIG. 3. The engine 202 may be positioned in the engine cab 300 such that the longitudinal axis of the engine is aligned in parallel with a length of the cab 300. As depicted in FIG. 2, a longitudinal axis of the exhaust gas treatment device is aligned in parallel with the longitudinal axis of the engine.

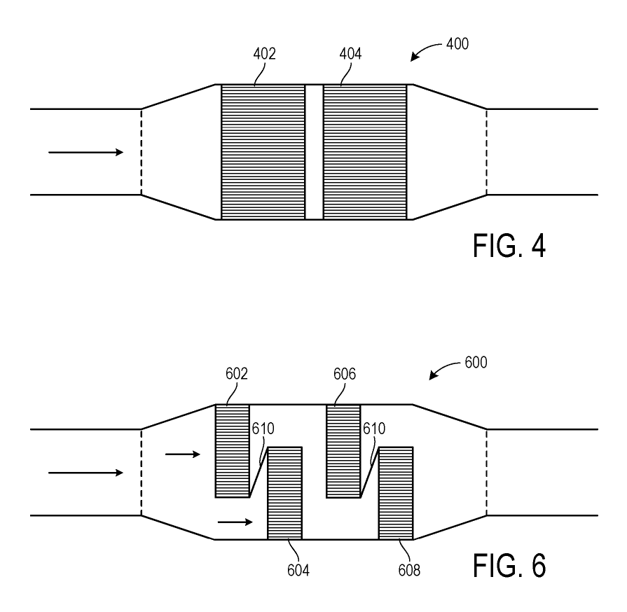

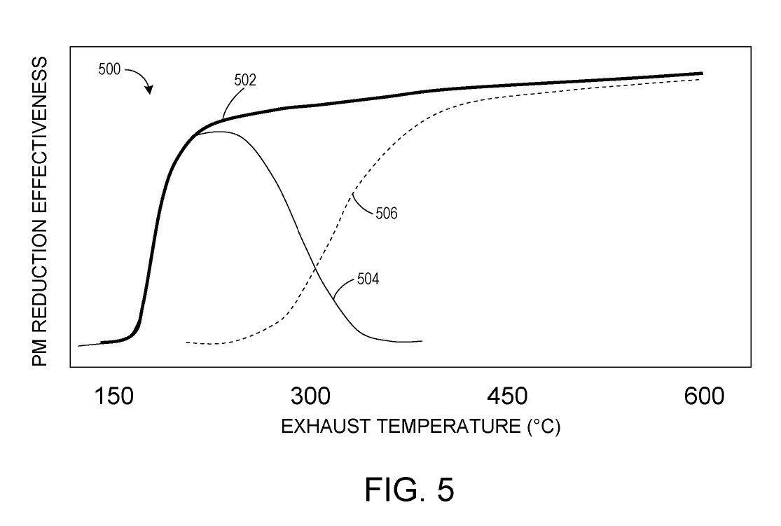

The exhaust gas treatment device 208 is defined by the exhaust passage aligned in parallel with the longitudinal axis of the engine. In the exemplary embodiment shown in FIG. 2, the exhaust gas treatment device 208 includes a first substrate coated with a low temperature catalyst 220 and a second substrate coated with a high temperature catalyst 222. As an example, the first substrate coated with the low temperature catalyst 220 may be a DOC and the second substrate coated with the high temperature catalyst 222 may be a catalyzed DPF, as will be described in greater detail below with reference to FIGS. 4 and 5.

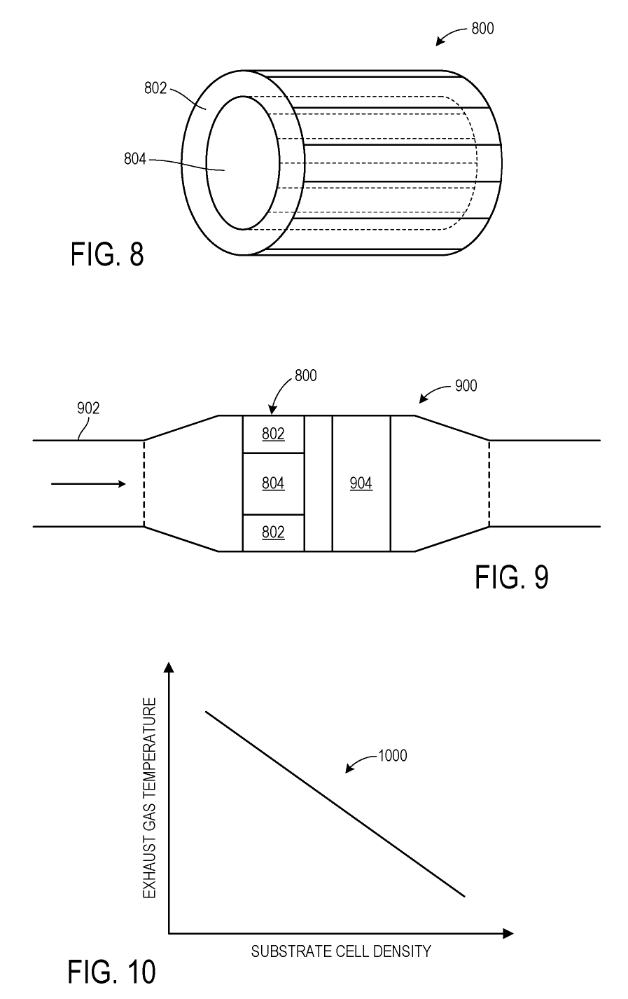

In another embodiment, the exhaust gas treatment device includes a first substrate coated with a first, low temperature catalyst and a second substrate coated with a second, high temperature catalyst, the first substrate and the second substrate positioned coaxially. The exhaust gas treatment device further includes a particulate filter, such as a DPF, disposed downstream of the first substrate and the second substrate. Such an example will be described in greater detail below with reference to FIGS. 8-13.

In other non-limiting embodiments, the engine system 200 may include more than one exhaust gas treatment device, such as DOC, a DPF coupled downstream of the DOC, and a selective catalytic reduction (SCR) catalyst coupled downstream of the diesel particulate filter. In another example embodiment, the exhaust gas treatment device may include an SCR system for reducing NOₓ species generated in the engine exhaust stream and a particulate matter (PM) reduction system for reducing an amount of particulate matter, or soot, generated in the engine exhaust stream. The various exhaust after-treatment components included in the SCR system may include an SCR catalyst, an ammonia slip catalyst (ASC), and a structure (or region) for mixing and hydrolyzing an appropriate reductant used with the SCR catalyst, for example. The structure or region may receive the reductant from a reductant storage tank and injection system, for example.

In another embodiment, the exhaust gas treatment device 208 may include a plurality of distinct flow passages aligned in a common direction (e.g., along the longitudinal axis of the engine). In such an embodiment, each of the plurality of flow passages may include one or more exhaust gas treatment devices which may each include a low temperature catalyst and a high temperature catalyst.

By positioning the exhaust gas treatment device on top of the engine such that the exhaust passage is aligned in parallel with the longitudinal axis of the engine, as described above, a compact configuration can be enabled. In this manner, the engine and exhaust gas treatment device can be disposed in a space, such as an engine cab as described above, where the packaging space may be limited.

Further, by positioning the exhaust gas treatment device upstream of the turbocharger, further compaction of the configuration may be enabled. For example, upstream of the turbocharger, exhaust gas emitted from the engine is still compressed and, as such, has a greater volume flow rate than exhaust gas that has passed through the turbocharger. As a result, a size of the exhaust gas treatment device may be reduced.

Continuing to FIG. 4, it shows an example embodiment of an exhaust gas treatment device 400 with a first substrate 402 coated with a low temperature catalyst and a second substrate 404 coated with a high temperature catalyst, where the second substrate 404 is disposed downstream of the first substrate 402, such as exhaust gas treatment device 208 described above with reference to FIG. 2.

The first substrate 402 may be a metallic (e.g., stainless steel, or the like) or a ceramic substrate, for example, with a monolithic honeycomb structure. The low temperature catalyst may be a coating of precious metal such as a platinum group metal (e.g., platinum, palladium, or the like) on the first substrate 402. Within a low temperature range, such as between 150° C. and 300° C., the low temperature catalyst may facilitate a chemical reaction. As such, the low temperature catalyst may operate during low load or idle conditions. In one embodiment, the low temperature catalyst may be a nitrogen oxide-based catalyst that converts NO to NO₂. As an example, the first substrate coated with the low temperature catalyst may be a diesel oxidation catalyst.

The second substrate 404 may be a ceramic (e.g., cordierite) or silicon carbide substrate, for example, with a monolithic honeycomb structure. The high temperature catalyst may be a coating of an oxidized ceramic material and/or a mineral on the second substrate 404. For example, the high temperature catalyst may be a base metal and/or a rare earth oxide (e.g., iron, copper, yttrium, dysprosium, and the like). Under a high temperature range, such as between 300° C. and 600° C., the high temperature catalyst may facilitate a chemical reaction. As such, the high temperature catalyst may operate during high load conditions or, in the case of a rail vehicle, when the rail vehicle is passing through a tunnel. In one embodiment, the high temperature catalyst may be an oxygen based catalyst that facilitates particulate matter (e.g., soot) consumption with excess O₂ in the exhaust stream. As an example, the second substrate coated with the high temperature catalyst may be a catalyzed diesel particulate filter. In some embodiments, the diesel particulate filter may be a wall flow particulate filter. In other embodiments, the diesel particulate filter may be a flow through particulate filter.

Thus, one embodiment relates to an exhaust gas treatment device. The device comprises a first substrate coated with a low temperature catalyst, which is a platinum group metal (e.g., platinum, palladium, ruthenium, rhodium, osmium, or iridium). The device further comprises a second substrate coated with a high temperature catalyst, which is at least one of a base metal and a rare earth oxide (e.g., iron, nickel, lead, zinc, cerium, neodymium, lanthanum, and the like), positioned downstream of the first substrate. The first and second substrates may be co-located in a common housing, the housing defining a passageway, and the first substrate located on an upstream end of the passageway.

In an embodiment, an exhaust gas treatment device comprised a first substrate coated with a low temperature catalyst, which is a mixture of platinum and rhodium. The device further comprises a second substrate coated with a high temperature catalyst, which is cerium oxide, positioned downstream of the first substrate. The first and second substrates may be co-located in a common housing, the housing defining a passageway, and the first substrate located on an upstream end of the passageway.

In an embodiment, an exhaust gas treatment device comprises a housing defining an internal passageway and a particulate matter filter in the passageway. The exhaust gas treatment device further comprises a first catalyst and a second catalyst disposed in the internal passageway, wherein the first catalyst is configured to oxidize particulate matter in the particulate matter filter in a first, low temperature range, and wherein the second catalyst is configured to oxidize particulate matter in the particulate matter filter in a second, high temperature range, and wherein the first and second catalysts operate to maintain a balance point of particulate loading of the particulate matter filter within a loading range.

Balance point operation of the particulate matter filter may be an operation in which particulate matter builds up on the filter at a particular rate and, due to catalyst operation, the particulate matter is consumed at a particular rate. For example, the balance point may be an equilibrium point in which build up and consumption of particulate matter occurs at substantially the same rate. The balance point may be based on engine operation, for example, such as exhaust temperature and engine load. Further, the balance point may be different for different particulate matter filters. As an example, a wall flow particulate matter filter may have a 90 percent (90%) capture rate of particulate matter, and a flow through particulate filter may have a 50 to 60 percent (50-60%) capture rate of particulate matter. Thus, the wall flow particulate matter filter may have a higher balance point than the flow through particulate matter filter.

As the balance point increases, particulate matter loading may increase, and as the balance point decreases, particulate matter consumption may increase. As the particulate matter loading reaches a critical point (e.g., the balance point increases to a critical point), active regeneration of the particulate matter filter may be initiated. As an example, the critical point may be a threshold amount of particulate matter in the filter, above which the effectiveness of the particulate matter filter decreases. Thus, the critical point may be a particulate matter filter loading at which active regeneration is initiated to remove particulate matter from the particulate matter filter. As such, the balance point may be maintained in a loading range below the critical point such that initiation of active regeneration is reduced. In one non-limiting embodiment, the loading range of the balance point may be within 20 to 30 percent (20-30%) of a critical point at which active regeneration of the particulate matter filter is initiated.

In another embodiment, an exhaust gas treatment device comprises a housing defining an internal passageway and a particulate matter filter in the passageway. The exhaust gas treatment device further comprises one or more catalysts disposed in the internal passageway, wherein the one or more catalysts are configured to oxidize particulate matter in the particulate matter filter in a first, low temperature range and in a second, high temperature range. Further, the low temperature operation will have a peak effectiveness at a certain temperature (e.g., between 150° C. and 300° C.). The effectiveness of the high temperature operation will increase with higher and higher temperature (e.g., between 300° C. and 600° C.).

FIG. 5 shows a graph 500 illustrating a particulate matter reduction in an exhaust gas treatment device, such as exhaust gas treatment device 400 described above with reference to FIG. 4, as a function of temperature. Curve 504 shows the temperature range in which the low temperature catalyst (e.g., the diesel oxidation catalyst) is most effective, which is in the temperature range between 150° C. and 300° C. Curve 506 shows the temperature range in which the high temperature catalyst (e.g., the catalyzed diesel particulate filter) is most effective, which is in the temperature range between 300° C. and 600° C.

As indicated by the curve 504 in FIG. 5, at lower exhaust temperatures, soot on the second substrate may be reduced by the low temperature catalyst. Further, at higher exhaust temperatures, the low temperature catalyst may not be effective due to its lower NO₂ conversion ratio. As such, the second substrate may be coated with a second, high temperature catalyst that facilitates the reduction of soot at higher exhaust temperatures.

As described above, the low temperature catalyst may be a nitrogen oxide-based catalyst that converts NO to NO₂. As such, the NO₂ formed at the first substrate may flow to the second substrate where it will consume soot, thereby cleaning the second substrate by passive regeneration during periods when the exhaust temperature is relatively low. Further, the high temperature catalyst may be an oxygen based catalyst that facilitates particulate matter consumption with excess O₂ in the exhaust stream. As such, during periods when the exhaust temperature is relatively high, soot consumption may occur by passive regeneration.

In other words, the low temperature catalyst (e.g., the DOC) converts NO to NO₂, which oxidizes the particulates in the particulate filter. This reaction is effective over the lower temperature range of 150° C. to 300° C. Above 300° C. the DOC is not effective in converting NO to NO₂. In the temperature range over 300° C., the high temperature catalyst (e.g., the particulate filter) is catalyzed to use the O₂ in the exhaust gas to oxidize the soot.

Thus, passive regeneration of the second substrate coated with the high temperature catalyst may occur over a wide range of temperatures (e.g., 150° C. and 600° C.), as indicated by curve 502 shown in FIG. 5. In this manner, a need for active regeneration due to particulate matter build-up in the second substrate may be reduced. As such, fuel consumption may be reduced as fuel injection for increasing temperature for active regeneration is reduced.

FIG. 6 shows another example embodiment of an exhaust gas treatment device 600. The exhaust gas treatment device 600 includes a first substrate coated with a low temperature catalyst and a second substrate coated with a high temperature catalyst, such as the first substrate 402 and the second substrate 404 described above with reference to FIG. 4. In the example embodiment of FIG. 6, each of the catalysts is divided into a plurality of sub-substrates which split the exhaust flow into a corresponding number of portions.

In the example embodiment of FIG. 6, the first substrate is divided into a first sub-substrate 602 and a second sub-substrate 604 disposed downstream of the first sub-substrate 602, thereby splitting the exhaust gas flow into two different portions. As depicted, the first sub-substrate 602 extends partially across a radial extent of the exhaust gas treatment device such that a portion of the radial extent at the location of the first sub-substrate is not filled by the first sub-substrate. As such, a first portion of exhaust gas flows through the first sub-substrate 602 and a second portion of exhaust gas bypasses the first sub-substrate 602 and flows through the second sub-substrate 604. As depicted, the second sub-substrate 604 extends partially across a radial extent of the exhaust gas treatment device such that a portion of the radial extent at the second sub-substrate is not filled by the second sub-substrate. In some embodiments, the first sub-substrate 602 and the second sub-substrate 604 may be coated by the same low temperature catalyst. In other embodiments, the first sub-substrate 602 and the second sub-substrate 604 may be coated by different low temperature catalysts.

Further, a flow divider 610 interconnects distal edges of the first sub-substrate 602 and the second sub-substrate 604 that are not abutting the walls of the exhaust gas treatment device 600. In this manner, the flow divider 610 channels exhaust gas around each of the sub-substrates 602 and 604 such that each portion of exhaust gas flow flows through only one of the sub-substrates 602 and 604.

Further, in the example embodiment of FIG. 6, the second substrate is divided into a first sub-substrate 606 and a second sub-substrate 608 disposed downstream of the first sub-substrate, thereby splitting the exhaust gas flow into two different portions. The second substrate is disposed downstream of the first substrate. As depicted, the first sub-substrate 606 extends partially across a radial extent of the exhaust gas treatment device such that a portion of the radial extent at the location of the first sub-substrate is not filled by the first sub-substrate. As such, a first portion of exhaust gas flows through the first sub-substrate 606 and a second portion of exhaust gas bypasses the first sub-substrate 606 and flows through the second sub-substrate 608. As depicted, the second sub-substrate 608 extends partially across a radial extent of the exhaust gas treatment device such that a portion of the radial extent at the second sub-substrate is not filled by the second sub-substrate. In some embodiments, the first sub-substrate 606 and the second sub-substrate 608 may be coated by the same high temperature catalyst. In other embodiments, the first sub-substrate 606 and the second sub-substrate 608 may be coated by different high temperature catalysts.

Further, a flow divider 610 interconnects distal edges of the first sub-substrate 606 and the second sub-substrate 608 that are not abutting the walls of the exhaust gas treatment device 600. In this manner, the flow divider 610 channels exhaust gas around each of the sub-substrates 606 and 608 such that each portion of exhaust gas flow flows through only one of the sub-substrates 606 and 608.

By dividing the first substrate into two sub-substrates 602 and 604, and dividing the second substrate into two sub-substrates 606 and 608, a surface area through which exhaust gas flows may be increased and a length along which each portion flows may be decreased, thereby reducing a pressure drop on the system. Further, in such a configuration, a size of the exhaust gas treatment device may be reduced, thus enabling the device to be positioned in a system that has limited space. As such, a more compact exhaust gas treatment device may be enabled, the more compact exhaust gas treatment device capable of passive regeneration over a wide range of temperatures, as described with reference to FIGS. 4 and 5.

It should be understood that FIG. 6 is provided as an example. The exhaust gas treatment device may include any suitable number of sub-substrates splitting the exhaust flow into a corresponding number of flow paths. In some embodiments, only the first substrate may be divided or only the second substrate may be divided. Further, a size and shape of each sub-substrate may vary based on the configuration of the sub-substrates within the exhaust gas treatment device.

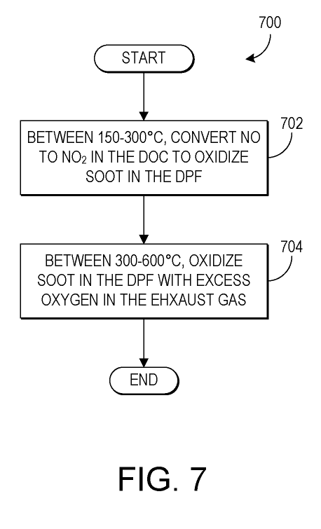

FIG. 7 shows a high level flow chart illustrating a method 700 for use of an exhaust gas treatment device, such as the exhaust gas treatment device 400 or 600 described above with reference to FIGS. 4 and 6, respectively.

At 702 of method 700, when exhaust gas temperatures are between 150° C. and 300° C., nitric oxide (NO) is converted to nitrogen dioxide (NO₂) in the diesel oxidation catalyst (DOC). As described above, the DOC may be coated with a low temperature catalyst, such as platinum, which facilitates the reaction. The NO₂ formed in the DOC flows to the diesel particulate filter (DPF) where it oxidizes particulate matter, such as soot, thereby passively regenerating the DPF at low temperatures.

At 704 of method 700, when exhaust gas temperatures are between 300° C. and 600° C., particulate matter such as soot is oxidized in the DPF with excess oxygen in the exhaust gas, thereby passively regenerating the DPF at high temperatures. As described above, the DPF may be coated with a high temperature catalyst which facilitates the oxidation of soot.

Thus, the DPF may be regenerated by passive regeneration over a wide range of temperatures. In this manner, fuel consumption may be reduced, thereby increasing fuel economy, as active regeneration may be carried out less frequently due to an increase in passive regeneration.

Another embodiment relates to an exhaust gas treatment device. The device comprises a first substrate and a second substrate positioned downstream of the first substrate (for example, the first and second substrates may be located in a common passageway defined by a housing). The first substrate is coated with a low temperature catalyst configured to operate under a first, low temperature range. The low temperature catalyst converts nitric oxide to nitrogen dioxide in the first, low temperature range. The second substrate is coated with a high temperature catalyst. The high temperature catalyst is configured to operate under a second, high temperature range. In the first and second temperature ranges, particulate matter is oxidized at the second substrate. More specifically, the nitrogen dioxide (generated by the low temperature catalyst and traveling downstream to the second substrate) oxidizes particulate matter in the second substrate in the first, low temperature range. Additionally, the high temperature catalyst reduces particulate matter in the second substrate with oxygen in exhaust gas when a temperature of the exhaust gas is in the second, high temperature range.

In another embodiment, an exhaust gas treatment device comprises a diesel oxidation catalyst and a diesel particulate filter located downstream of the diesel oxidation catalyst. The diesel oxidation catalyst has a first catalyst for converting nitric oxide to nitrogen dioxide for oxidizing particulate matter in the diesel particulate filter in a first, low temperature range. The diesel particulate filter has a second catalyst for oxidizing particulate matter in the diesel particulate filter in a second, high temperature range.

In another embodiment, an exhaust gas treatment device comprises a housing defining an internal passageway, a particulate matter filter in the passageway, and a plurality of catalysts disposed in the internal passageway. The plurality of catalysts is configured to oxidize particulate matter in the particulate matter filter in a first, low temperature range and in a second, high temperature range (e.g., one catalyst may work in the low temperature range, and another catalyst in the high temperature range).

In some examples, an engine system may be retrofitted with an exhaust gas treatment device as described in any of the embodiments herein. The exhaust gas treatment device may be added to the engine system in any suitable location in the exhaust passage, for example, the exhaust gas treatment device may be installed upstream or downstream of the turbine of the turbocharger.

Further, in some examples, an engine may be serviced by replacing an exhaust gas treatment device with an exhaust gas treatment device as described in any of the embodiments herein. In such an example, the exhaust gas treatment device may be replaced such that fuel economy of the engine system may be increased.

FIGS. 8-11 show embodiments of an oxidation catalyst, such as a diesel oxidation catalyst (DOC), and embodiments of the oxidation catalyst disposed in an exhaust gas treatment device. In particular, FIG. 8 shows an exemplary embodiment of an oxidation catalyst device which includes a first substrate and a second substrate positioned coaxially, while FIG. 9 shows an example embodiment of the oxidation catalyst device depicted in FIG. 8 disposed in an exhaust gas treatment device. FIG. 11 shows an exemplary embodiment of an oxidation catalyst device with a first substrate, a second substrate positioned coaxially with the first substrate, and a flow control element which controls flow through the first substrate. FIG. 12 shows an exemplary embodiment of the oxidation catalyst device depicted in FIG. 11 disposed in an exhaust gas treatment device.

FIG. 8 shows an oxidation catalyst device 800 with a first substrate 802 and a second substrate 804 positioned coaxially with the first substrate 802. The first substrate 802 may be a metallic (e.g., stainless steel, or the like) or a ceramic substrate, for example, with a monolithic honeycomb structure. Similarly, the second substrate 804 may be a metallic (e.g., stainless steel, or the like) or a ceramic substrate, for example, with a monolithic honeycomb structure. In some examples, the first substrate 802 and the second substrate 804 may be made of the same material. In other examples, the first substrate 802 and the second substrate 804 may be made of different materials.

The first substrate 802 may be coated with a low temperature catalyst. As an example, the low temperature catalyst may be platinum. Under a low temperature range, such as between 300° C. and 500° C., the low temperature catalyst may facilitate a chemical reaction. As such, the low temperature catalyst may operate during low load or idle conditions when an exhaust temperature is relatively low. In one embodiment, the low temperature catalyst may facilitate conversion of CO and hydrocarbons to water and CO₂. The low temperature catalyst may further be a nitrogen oxide-based catalyst which facilitates conversion of NO to NO₂.

The second substrate 804 may be coated with a high temperature catalyst. As an example, the high temperature catalyst may be a mixture of platinum and palladium. In one example, the high temperature catalyst may be made of four parts platinum and one part palladium by weight. Under a high temperature range, such as between 500° C. and 600° C., the high temperature catalyst may facilitate a chemical reaction. As such, the high temperature catalyst may operate during conditions when an exhaust temperature is relatively high. Conditions in which the exhaust gas temperature is relatively high may include tunneling operation in which the vehicle is travelling through a tunnel, active regeneration of the particulate filter in which the exhaust gas temperature is increased to facilitate regeneration of the particulate filter, and/or conditions in which degradation of a component such as a turbocharger has occurred. In one embodiment, the high temperature catalyst may facilitate conversion of CO and hydrocarbons to water and CO₂. The high temperature catalyst may further be a nitrogen oxide-based catalyst which facilitates conversion of NO to NO₂.

In one embodiment, each of the two substrates may have a different cell density. For example, the first substrate 802 may have a higher cell density than the second substrate 804. In one example, the first substrate 802 may have a cell density between 46.5 and 77.5 cell per square centimeter (300 and 500 cells per square inch) and the second substrate 804 may have a cell density of less than 46.5 cells per square centimeter. In one non-limiting embodiment, the second substrate 804 may have a cell density of 31 cells per square centimeter (200 cells per square inch). In this manner, the flow resistance between the substrates may be different, and as such, higher temperature and lower temperature exhaust gas flows may be more likely to flow through one substrate or the other and the exhaust gas flow may be passively directed through one substrate or the other based on the temperature. As an example, the first substrate 802 with the higher cell density may form a first flow path along which exhaust gas flows at lower temperatures and the second substrate 804 with the lower cell density may form a second flow path along which exhaust gas flows at higher temperatures.

As an example of the dependence of flow through a substrate and cell density, FIG. 10 shows a graph 1000 illustrating an example of flow through a substrate based on exhaust gas temperature and substrate cell density. As depicted in FIG. 10, exhaust gas flow at a lower temperature prefers a higher substrate cell density. Exhaust gas flow at a higher temperature prefers a lower substrate cell density. By coating the substrate with a higher cell density with the low temperature catalyst and coating the substrate with the lower cell density with the high temperature catalyst, high temperature exhaust gas flows may be more likely to flow through the substrate with the lower cell density coated with the high temperature catalyst. In this manner, the degradation of the low temperature catalyst may be reduced during conditions in which the exhaust temperature is high. In some examples, lower temperature exhaust gas may flow through the first substrate (e.g., 802) coated with the low temperature catalyst and the second substrate (e.g., 804) coated with the high temperature catalyst.

Referring back to FIG. 8, the second substrate 804 coated with the high temperature catalyst is positioned in the center of the oxidation catalyst device 800 and the first substrate 802 coated with the low temperature catalyst surrounds the circumference of the second substrate. It should be understood that the oxidation catalyst is not limited to this configuration. In other embodiments, the first substrate coated with the low temperature catalyst may be positioned in the center of the oxidation catalyst and the second substrate coated with the high temperature catalyst may surround the circumference of the first substrate.

By positioning the first substrate 802 and the second substrate 804 coaxially, each of the substrates 802 and 804 are in the proximity of the heat source (e.g., the exhaust gas). As such, when exhaust gas flow to one of the substrates is reduced, the temperature of the other substrate may not drop significantly such that it falls below its activation temperature. For example, when a high temperature exhaust flow flows primarily through the second substrate 804 coated with the high temperature catalyst and the first substrate 802 coated with the low temperature catalyst receives a reduced exhaust gas flow, the temperature of the first substrate 802 may not drop below its activation temperature. In this manner, when the exhaust gas temperature decreases such that exhaust flow through the first substrate 802 increases, the first substrate 802 coated with the low temperature catalyst is ready for conversion of NO to NO₂ without having to wait for the first substrate 802 to warm-up.

Turning now to FIG. 9, an exemplary embodiment of an exhaust gas treatment device 900 disposed in an exhaust passage 902 is depicted. The exhaust gas treatment device 900 includes the oxidation catalyst device 800 described above with reference to FIG. 8. As depicted, the exhaust gas treatment device 900 further includes a particulate filter 904, such as a DPF, disposed downstream of the first substrate 802 and the second substrate 804 of the oxidation catalyst device 800. The particulate filter 904 may include a substrate such as a ceramic (e.g., cordierite) or silicon carbide substrate, for example, with a monolithic honeycomb structure. In some examples, such as described above with reference to FIGS. 4 and 6, the particulate filter 904 may be a catalyzed particulate filter coated with a catalyst. As an example, the particulate filter 904 may be coated with a catalyst such as an oxidized ceramic material and/or a mineral, as described above. In some embodiments, the diesel particulate filter may be a wall flow particulate filter. In other embodiments, the diesel particulate filter may be a flow through particulate filter.

By positioning the particulate filter 904 downstream of the oxidation catalyst 800, an oxidizer generated by the oxidation catalyst device 800, such as NO₂, may flow to the particulate filter, thereby facilitating the oxidation of particulate matter trapped in the particulate filter 904. In this way, passive regeneration of the particulate filter 904 may be carried out over a range of exhaust gas temperatures (e.g., 300-600° C.), and a need for active regeneration of the particulate filter 904 may be reduced.

FIG. 11 shows another example of an oxidation catalyst device 1100, such as a DOC, which includes a first substrate 1102 coated with a first, low temperature catalyst and a second substrate 1104 coated with a second, high temperature catalyst. As described above, the first substrate 1102 and the second substrate 1104 may be metallic (e.g., stainless steel, or the like) or ceramic substrates, for example, with a monolithic honeycomb structure. In some examples, the first substrate 1102 and the second substrate 1104 may be made of the same material. In other examples, the first substrate 1102 and the second substrate 1104 may be made of different materials.

The first substrate 1102 may be coated with a low temperature catalyst. As an example, the low temperature catalyst may be platinum. The low temperature catalyst may facilitate a chemical reaction under a low temperature range, such as between 300° C. and 500° C. As such, the low temperature catalyst may operate during low load or idle conditions when an exhaust temperature is relatively low. In one embodiment, the low temperature catalyst may facilitate conversion of CO and hydrocarbons to water and CO₂. The low temperature catalyst may further be a nitrogen oxide-based catalyst which facilitates conversion of NO to NO₂.

The second substrate 1104 may be coated with a high temperature catalyst. As an example, the high temperature catalyst may be a mixture of platinum and palladium. In one example, the high temperature catalyst may be made of four parts platinum and one part palladium by weight. The high temperature catalyst may facilitate a chemical reaction under a high temperature range, such as between 500° C. and 600° C. As such, the high temperature catalyst may operate during conditions when an exhaust temperature is relatively high, as described above. For example, conditions in which the exhaust gas temperature is relatively high may include tunneling operation, active regeneration of the particulate filter, and/or conditions in which degradation of a component such as a turbocharger has occurred. In one embodiment, the high temperature catalyst may facilitate conversion of CO and hydrocarbons to water and CO₂. The high temperature catalyst may further be a nitrogen oxide-based catalyst which facilitates conversion of NO to NO₂.

As depicted in FIG. 11, the oxidation catalyst device 1100 further includes a flow control element 1106 operably coupled with the first substrate 1102 which may be controlled by a controller, such as the controller 148 described above with reference to FIG. 1, in order to actively direct the exhaust gas flow along a first flow path through the first substrate 1102 or along a second flow path through the second substrate 1104. In the example embodiment depicted in FIG. 11, the first substrate 1102 is disposed in a housing 1108, such as a pipe or other suitable conduit. The flow control element 1106 may be a valve, such as an on/off valve, a flow control valve, or a diverter valve. In other examples, the flow control element 1106 may be a flap that is capable of covering and blocking exhaust gas flow to the first substrate 1102. A position of the flow control element 1106 governs an extent to which exhaust gas flows through the first substrate. For example, when the flow control element is closed, exhaust gas may not pass through the first substrate 1102, and, instead, is directed along a second flow path through the second substrate 1104. On the other hand, when the exhaust gas valve is open, exhaust gas may flow through the first substrate 1102 and the second substrate 1104.

The housing 1108 may allow at least some heat transfer between the first substrate 1102 and the second substrate 1104. As such, even when the flow control element 1106 is closed so that high temperature exhaust gas does not flow through the first substrate 1102, a temperature of the first substrate 1102 may be maintained above an activation temperature. In this manner, when the flow control element 1106 is opened, the temperature of the first substrate 1102 is greater than the activation temperature such that the low temperature catalyst coated on the first substrate 1102 may resume conversion of NO to NO₂ with little to no delay.

In some embodiments, the first substrate 1102 and the second substrate 1104 may have different cell densities, as described above with reference to FIG. 8. As an example, the first substrate 1102 coated with the low temperature catalyst may have a higher cell density than the second substrate 1104 coated with the high temperature catalyst. As the higher cell density may be more restrictive to a higher temperature exhaust gas (FIG. 10), the higher temperature exhaust gas may be more likely to flow along the second flow path through the second substrate 1104 with the lower cell density. When the flow control element is in an open position, the lower temperature exhaust gas may be more likely to flow along the first flow path through the first substrate 1102 with the higher cell density.

As depicted in FIG. 11, the first substrate 1102 coated with the low temperature catalyst is positioned in the center of the oxidation catalyst device 1100 and the second substrate 1104 coated with the high temperature catalyst surrounds the circumference of the first substrate 1102. In other embodiments, the second substrate 1104 coated with the high temperature catalyst may be positioned in the center of the oxidation catalyst and the first substrate 1102 coated with the low temperature catalyst may surround the circumference of the second substrate 1104. In such a configuration, the flow control element 1106 may control the flow of exhaust gas through the second substrate 1104.

FIG. 12 shows an exemplary embodiment of an exhaust gas treatment device 1200 disposed in an exhaust passage 1202. The exhaust gas treatment device 1200 includes the oxidation catalyst device 1100 described above with reference to FIG. 11. As depicted, the exhaust gas treatment device 1200 further includes a particulate filter 1204, such as a DPF or other particulate matter filter, disposed downstream of the first substrate 1102 and the second substrate 1104 of the oxidation catalyst device 1100. The particulate filter 1204 may include a substrate such as a ceramic (e.g., cordierite) or silicon carbide substrate, for example, with a monolithic honeycomb structure. In some examples, such as described above with reference to FIGS. 4 and 6, the particulate filter 1204 may be a catalyzed particulate filter coated with a catalyst. As an example, the particulate filter 1204 may be coated with a catalyst such as an oxidized ceramic material and/or a mineral, as described above. In some embodiments, the diesel particulate filter may be a wall flow particulate filter. In other embodiments, the diesel particulate filter may be a flow through particulate filter.

The exhaust gas treatment device 1200 further includes a flow control element 1106 operably coupled to the first substrate 1102 via a housing 1108. By adjusting the flow control element 1106 to direct the flow of exhaust gas through the first substrate 1102 or the second substrate 1104, an oxidizer may be generated by the low temperature catalyst and/or high temperature catalyst during a range of exhaust gas temperatures (e.g., 300-600° C.), including low and high exhaust gas temperatures. With the particulate filter 1204 positioned downstream of the oxidation catalyst device 1100, the oxidizers generated by the low and high temperature catalysts may flow to the particulate filter 1204, and passive regeneration of the particulate filter 1204 may be carried out over a range of exhaust gas temperatures without degrading the low temperature catalyst.

In one embodiment, a method for an exhaust gas treatment device, such as the exhaust gas treatment device 900 described above with reference to FIG. 9 or the exhaust gas treatment device 1200 described above with reference to FIG. 12, comprises the step of determining a temperature of exhaust gas flowing through the exhaust passage. The method further comprises, when the temperature of the exhaust gas is less than a threshold temperature, selectively directing the exhaust gas along a first flow path through a first substrate coated with a low temperature catalyst which converts nitric oxide to nitrogen dioxide, and when the temperature of the exhaust gas is greater than the threshold temperature, selectively directing the exhaust gas along a second flow path through a second substrate coated with a high temperature catalyst which converts nitric oxide to nitrogen dioxide, the second substrate positioned coaxially with the first substrate within the exhaust gas treatment device. The method further comprises oxidizing particulate matter with the nitrogen dioxide in a particulate filter disposed downstream of the first substrate and the second substrate.

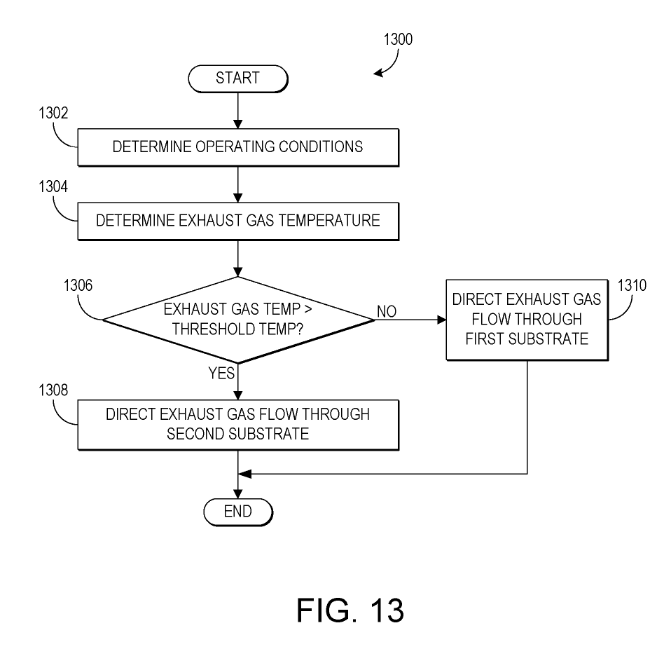

FIG. 13 shows a flow chart illustrating a method 1300 for an exhaust gas treatment device, such as the exhaust gas treatment device 900 described above with reference to FIG. 9 or the exhaust gas treatment device 1200 described above with reference to FIG. 12. Specifically, the method determines the temperature of exhaust gas flowing through the exhaust passage and directs the flow of the exhaust gas through a first and/or second substrate of an oxidation catalyst disposed in the exhaust gas treatment device accordingly.

At 1302, operating conditions are determined. As non-limiting examples, the operating conditions may include engine load conditions, environmental conditions (e.g., tunneling operation, ambient temperature, ambient pressure, and the like), exhaust conditions (e.g., temperature, pressure, and the like), and the like.

At 1304, the exhaust gas temperature is determined. The exhaust gas temperature may be determined based on temperature sensor measurements from temperature sensors in the exhaust passage, for example. In some examples, the method does not require determination of the specific temperature, but determination if the temperature is above or below a threshold temperature.

Once the exhaust temperature is determined, it is determined if the exhaust gas temperature is greater than a threshold temperature at 1306. The threshold temperature may be based on the composition of the catalysts in the exhaust gas treatment device. In one example, the threshold temperature may be 500° C. In other examples, the threshold temperature may be greater than 500° C. or less than 500° C.

If it is determined that the exhaust gas temperature is greater than the threshold temperature, the method continues to 1308 where the exhaust gas flow is selectively directed along a second flow path through the second substrate coated with the high temperature catalyst. In some examples, such as in the exhaust gas treatment device depicted in FIG. 9, the exhaust gas flow may be passively directed through the second substrate based on a cell density of the substrate, as described above. For example, the second substrate coated with the high temperature catalyst may have a lower cell density than the first substrate coated with the low temperature catalyst. The higher temperature exhaust gas, which has a higher flow rate than lower temperature exhaust gas, may favor the lower cell density substrate, and as such, the high temperature exhaust flow may flow through the second substrate coated with the high temperature catalyst. In this manner, flow of high temperature exhaust gas through the first substrate coated with the low temperature catalyst may be reduced and degradation of the low temperature catalyst may be reduced.

In other examples, such as in the exhaust gas treatment device depicted in FIG. 12, the exhaust gas flow may be actively directed through the second substrate based on actuation of a flow control element, such as the flow control element 1106 described above with reference to FIGS. 11 and 12, as described above. For example, the flow control element may be closed once it is determined that the exhaust gas temperature is greater than the threshold temperature. In this manner, exhaust gas flow through the first substrate coated with the low temperature catalyst may be substantially reduced or cut-off, thereby reducing degradation of the low temperature catalyst.

On the other hand, if it is determined that the exhaust gas temperature is less than the threshold temperature at 1306, the method moves to 1310 where the exhaust gas flow is directed through the first substrate coated with the low temperature catalyst. In some examples, the exhaust flow may be directed through the first substrate based on a cell density of the substrate. As described above, the first substrate coated with the low temperature catalyst may have a higher cell density than the second substrate coated with the high temperature catalyst. The lower temperature gas, which has a lower flow rate than the high temperature gas, may favor the higher cell density substrate, and as such, the low temperature exhaust flow may flow through the first substrate coated with the low temperature catalyst.

Thus, exhaust gas flow through an oxidation catalyst including a first substrate coated with a low temperature catalyst and a second substrate coated with a high temperature catalyst may be controlled based on a temperature of the exhaust gas. By controlling the flow of exhaust gas through the substrates, while not thermally isolating the substrates from the heat source, a temperature of the substrates and corresponding catalysts may be maintained above an activation temperature such that oxidizer formation may be resumed quickly when exhaust gas flow through the substrate is resumed.

As explained above, the terms “high temperature” and “low temperature” are relative, meaning that “high” temperature is a temperature higher than a “low” temperature. Conversely, a “low” temperature is a temperature lower than a “high” temperature. As used herein, the term “between,” when referring to a range of values defined by two endpoints, such as between value “X” and value “Y,” means that the range includes the stated endpoints.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An exhaust gas treatment device, comprising:
a first substrate coated with a low temperature catalyst configured to facilitate formation of an oxidizer when an exhaust gas temperature is below a threshold temperature; and
a second substrate coated with a high temperature catalyst and positioned coaxially with the first substrate, the high temperature catalyst configured to facilitate formation of the oxidizer when the exhaust gas temperature is above the threshold temperature.

2. The exhaust gas treatment device of claim 1, wherein the first substrate has a higher cell density to reduce flow through the first substrate at the high temperature, and wherein the second substrate has a lower cell density to increase flow through the second substrate at the high temperature.

3. The exhaust gas treatment device of claim 2, wherein the cell density of the first substrate is 46.5 to 77.5 cells per square centimeter and the cell density of the second substrate is less than 46.5 cells per square centimeter.

4. The exhaust gas treatment device of claim 1, wherein the second substrate is positioned in a center of the exhaust gas treatment device and the first substrate surrounds a circumference of the second substrate.

5. The exhaust gas treatment device of claim 1, wherein the first substrate is positioned in a center of the exhaust gas treatment device and the second substrate surrounds a circumference of the first substrate.

6. The exhaust gas treatment device of claim 5, further comprising a flow control element operably coupled with the first substrate such that a position of the flow control element governs an extent to which exhaust gas flows along a first flow path through the first substrate.

7. The exhaust gas treatment device of claim 1, wherein the low temperature catalyst is platinum, and wherein the oxidizer is nitrogen dioxide.

8. The exhaust gas treatment device of claim 1, wherein the high temperature catalyst is platinum and palladium, and wherein the oxidizer is nitrogen dioxide.

9. The exhaust gas treatment device of claim 8, wherein the high temperature catalyst is four parts platinum and one part palladium by weight.

10. The exhaust gas treatment device of claim 1, wherein the threshold temperature is 500° C.

11. The exhaust gas treatment device of claim 1, wherein the first substrate coated with the low temperature catalyst and the second substrate coated with the high temperature catalyst form an oxidation catalyst.

12. The exhaust gas treatment device of claim 1, further comprising a particulate filter disposed downstream of the first substrate and the second substrate.

13. A method for use of an exhaust gas treatment device positioned in an exhaust passage of an engine, comprising the steps of:
determining whether a temperature of exhaust gas flowing through the exhaust passage is less than or greater than a threshold temperature;
where, when the temperature of the exhaust gas is less than the threshold temperature, selectively directing the exhaust gas along a first flow path through a first substrate coated with a first, low temperature catalyst which converts nitric oxide to nitrogen dioxide; and
where, when the temperature of the exhaust gas is greater than the threshold temperature, selectively directing the exhaust gas along a second flow path through a second substrate coated with a second, high temperature catalyst which converts nitric oxide to nitrogen dioxide, the second substrate positioned coaxially with the first substrate within the exhaust gas treatment device; and
oxidizing particulate matter with the nitrogen dioxide in a particulate filter disposed downstream of the first substrate and the second substrate.

14. The method of claim 13, wherein the threshold temperature is 500° C.

15. The method of claim 13, wherein the first, low temperature catalyst is platinum, and the second, high temperature catalyst is four parts platinum and one part palladium by weight.

16. The method of claim 13, further comprising selectively directing the exhaust gas along the first flow path or the second flow path based on a cell density of the first and second substrates, and wherein the cell density of the first substrate is 46.5 to 77.5 cells per square centimeter, and the cell density of the second substrate is less than 46.5 cells per square centimeter.

17. The method of claim 13, further comprising selectively directing the exhaust gas along the second flow path by closing a flow control element operably coupled with the first substrate when the temperature of the exhaust gas is greater than the threshold temperature.

18. A system, comprising:
an engine with an exhaust passage through which exhaust gas from the engine flows;
an exhaust gas treatment device disposed in the exhaust passage, the exhaust gas treatment device including a first substrate coated with a first, low temperature catalyst and positioned coaxially with a second substrate coated with a second, high temperature catalyst, and a flow control element operably coupled with the first substrate; and
a controller configured to identify a temperature of the exhaust gas, and when the temperature of the exhaust gas is less than a threshold temperature, opening the flow control element to selectively direct the exhaust gas along a first flow path through the first substrate, and when the temperature of the exhaust gas is greater than the threshold temperature, closing the flow control element to selectively direct the exhaust gas along a second flow path through the second substrate.

19. The system of claim 18, wherein the threshold temperature is 500° C., and the first, low temperature catalyst is platinum and the second, high temperature catalyst is four parts platinum and one part palladium by weight.

20. The system of claim 18, wherein the first substrate is positioned in a center of the exhaust gas treatment device and the second substrate surrounds a circumference of the first substrate.

21. The system of claim 18, wherein the first, low temperature catalyst converts nitric oxide to nitrogen dioxide, and the second, high temperature catalyst converts nitric oxide to nitrogen dioxide.

22. The system of claim 18, wherein the exhaust gas treatment device further includes a particulate filter disposed downstream of the first substrate and the second substrate.
